(19) United States
(12) Patent Application Publication
(10) Pub. No.: US 2004/0149924 A1
(43) Pub. Date: Aug. 5, 2004

(54) Method, apparatus and device for real-time characterization of a radiation beam

(76) Inventor: Kevin J. Russell, Melbourne, FL (US)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/357,300

(22) Filed: Feb. 3, 2003

(51) Int. Cl. G01T 1/00

(52) U.S. Cl. 250/394

(57) ABSTRACT

Disclosed is radiation beam analyzer and method of using same, the analyzer having a matrix having a plurality of slots for removably receiving one or more radiation detector modules, and a processor in data communication with each said module, said processor adapted to receive and process radiation data from said radiation detector modules and provide said processed data to a user.

### BACKGROUND OF THE INVENTION

1. Field of the Invention

The present invention relates to a method, apparatus and device for characterizing a radiation beam, particularly those radiation beams used in clinical (e.g., oncology) applications for radiation therapy, especially IMRT.

2. Prior Art

The present invention relates to the general problem of characterizing a radiation beam, and more particularly to a radiation beam as used in clinical (oncology) applications for radiation therapy. These radiation therapy beams must be Quality Assurance (QA) certified for the purpose of guaranteeing quality treatment of the patient. This characterization of the beam also relates to the safety of patients undergoing radiation treatment.

In recent years, technology has brought about a new level of complexity to the problem of beam characterization—particularly in radiation therapy applications. The general class that these new technologies fall under is called Intensity Modulated Radiation Therapy (IMRT). The essence of IMRT techniques is to vary the characteristics of the radiation therapy beam in real time, while the radiation treatment is actually taking place. These characteristics that are varied include spatial (geometrical), energy, and temporal parameters.

The problem is that, in order to plan a quality treatment, it is desirable to establish the therapy beam characteristics prior to the treatment. This requires instrumentation that is able to record the radiation beam characteristics in real time and at different spatial locations. As may be expected, such instrumentation is immensely complex and costly. Before IMRT technologies, such as Dynamic Wedging (DW) and Multi Leaf Collimator (MLC) technology, characterization of the radiation therapy beam was a much simpler problem to resolve, thereby requiring simpler instrumentation. In simple terms, before IMRT techniques the radiation therapy beams were essentially static in their characteristics, whereas with the introduction of IMRT technologies the beams are highly dynamic. Hence, beam characterization instruments that can handle pre-IMRT conditions quite well are inadequate to handle the IMRT environment.

For the most part, engineers attempted to extend the use of these pre-IMRT instruments into the IMRT arena, for example, by employing a linear array of radiation detectors one could get a cross-section of the radiation beam—obviously not the two-dimensional (planar) footprint of the entire beam. One solution proposed is to use the linear array to scan the beam to obtain the entire footprint of the radiation. Scanning, however, takes time and one must recall that with IMRT the beam is being modified in real time. Hence, it is very possible that by the time that the scanning array reaches a particular location, that location has been modified one or more times by the IMRT method. This will not provide the desired and needed beam characterization.

Another solution proposed is to construct a planar (two-dimensional) array, but there are a great many hurdles to this. Aside from many engineering obstacles, one of the most significant problems is that the electronic components of any device, usually arranged in an array, are subject to high energy radiation, such as is present in the radiation therapy beams. As a consequence, degradation and eventual failure of such electronic components that are being subjected to high-energy radiation, such as that present in radiation therapy beams creates a problem of replacement. The problem is that these arrays are highly complex and costly—replacing them is neither easily nor inexpensively done—and the failure of any component renders the entire array useless.

The foregoing briefly depicts several limitations of the present technology regarding the general problem of characterizing a radiation beam. As noted, these problems are further compounded with radiation therapy beams employed in clinical (oncology) applications due to the emergence of IMRT technologies.

There still exists a need in the art for a solution to this problem whereby the failure of any one component does not render useless the rest of the array.

### SUMMARY OF THE INVENTION

The principal object of the present invention is to provide a method, apparatus and device for real-time characterization of a radiation beam that solves the above problem and overcomes the disadvantages and drawbacks of the prior art.

This is accomplished by the present invention by providing a novel method and device for characterizing a radiation beam in real time. The method, unique and advancing the state-of-the-art, employs radiation detectors (these detectors may be solid state diodes, ion chambers, and/or any other type of radiation detector) that are manufactured into basic elements called “detector modules”. These modules are inserted into a base substrate system containing cavities for the modules to be inserted into. The number and configuration of these modules may be modified to meet the requirements of the user. There is some localized processing of the signal acquired by the detectors further making this device and method unique. The modular design also provides distinct advantages over existing systems regarding radiation damage, manufacturing, and maintenance issues.

The invention provides a method, apparatus and device by which a radiation beam—of any radiation type (e.g., photons, such as X-rays or higher energies, electrons, or other radiation types), or from any source (pulsed accelerators, continuous emission sources, or any other radiation source)—may be characterized. The method, apparatus and device perform the characterization by employing readings obtained from an array of radiation detectors (these detectors may be solid state, such as, diodes, ion chambers, and/or any other type of radiation detector. The array of radiation detectors (these detectors may be solid state (diodes), ion chambers, and/or any other type of radiation detector) is assembled from basic/elemental units called “modules”. Specifically, first the individual radiation detectors—be they solid state (diodes), ion chamber, and/or any other type of radiation detector—are assembled to make up the modules. These modules then become the basic (elemental) building blocks with which to construct the array. The modules are inserted into a base substrate for the purpose of constructing a specific configuration of these detectors. Two (2) examples follow: (1) a line of the modules may be plugged into the substrate to construct a linear array of detectors, (2) a two dimensional array three-by-three (3×3) for a total of nine (9) of these modules may be plugged into the substrate to build a two-dimensional detector array. These two examples are not meant to limit the number of possible configurations, but only to illustrate two of the many possibilities, A three-dimensional array is also part of this invention in that detectors are vertically stacked along the module. Thus, the two-dimensional array has the 3rd dimension added with vertically placed detectors. The substrate contains distinct and varied hole patterns that the individual modules are inserted into. This hole pattern assortment allows for a large variety of modular array configurations to be constructed as illustrated and explained hereinafter. Some of the raw data obtained by the detectors/device is processed at each individual module. In other words, there is a certain amount of local data processing—“local” meaning, at the module level. These data are then multiplexed, A/D converted, mathematically transformed, and finally made available for utilization by an end user.

The inventive method, apparatus and device addresses and answers all of the limitations of the prior art. Specifically, and responding to the earlier identified limitations, the method, apparatus and device enables a real-time characterization of a radiation beam—whether in therapy or any other application—by employing a 2-D or 3-D array of detectors. The novel device will employ solid state (diodes), ion chambers, and/or any other type of radiation detector. The individual radiation detectors (solid state (diodes), ion chambers, and/or any other type of radiation detector) are assembled into basic array elements called “modules”, These modules are inserted into a substrate system that contains hole patterns for the modules to be inserted into. The number and configuration of these modules may be modified to meet the requirements of the user. For instance, (1) a line of these modules may be inserted into the substrate to construct a linear array of detectors (a single line of detectors) or, (2) four-by-four (4×4) for a total of sixteen (16) of these modules may be inserted into the substrate to build a two-dimensional detector array. These two examples are meant only to illustrate two of the many possibilities. Also, if the modules are constructed with vertically stacked detectors, then the device has a three-dimensional measurement capability. The important point is that the user may build the exact array—in size and configuration (shape)— required to meet the need.

It must be emphasized that the key feature of the method, apparatus and device is the 2-D and 3-D modular strategy. An array is not what makes the invention singularly unique—it is a modular 2-D and 3-D aspect that makes the invention unique and superior in, many ways. Combined with the information stated above, this important distinction is further illustrated and expanded in what follows.

Partial processing of the signal acquired by the individual detectors is done at the modular level further making this device and method unique. Specifically, signal integration and other processing is carried out at each individual module. These processed signals are then carried to another part of the device where multiplexing of the signals takes place. Finally, the multiplexed data are then processed through analog-to-digital (A/D) components. These digital data are now ready to be mathematically processed and displayed to the user. This design is superior to and has many advantages over any present system by offering greater simplicity, capability, reliability, aid maintainability all at lower cost.

The modular design also provides for numerous advantages over existing systems in matters regarding radiation damage, manufacturing, maintenance and repair. In present arrays, the incapacitation of an array element during manufacturing or due to radiation damage generally means a costly, time consuming repair process since the entire array is built as a single, integrated unit. The inventive modular approach means that when a single detector or module is or becomes inoperative for whatever reasons (such as due to radiation damage) there that element and only that element needs to be replaced. This feature makes for a more robust design and enhances the manufacturing process significantly. Also, the modular design of the device enables this type of repair to be performed by the user simply by extracting the damaged module and replacing it with a new module. With current systems the user has no choice but to send the complete unit to the manufacturer for repair. The time and cost implications to the end user of our modular design are readily apparent,

Finally, the following attribute of the novel modular concept/device actually extends the life of the modules: as interior modules—referring to those that are in the center of the radiation beam—start to suffer radiation damage, they may be rotated (i.e., exchanged) with the exterior modules—those lying at the outskirts of the radiation beam (and, hence, suffering less radiation damage). This ability to rotate modules will prolong the module's life resulting in fewer overall repairs to the device. In present systems, radiation damage to part of the array renders the entire array defective (again due to the fact that entire array is a single unit). In summary, our modular concept and design encompasses many distinctly superior advantages over any existing system and is therefore a clear advancement in the state-of-the-art.

The present invention provides a solution to the problem discussed above. By the present invention, a radiation beam analyzer is provided in the form of a two dimensional array, or a three dimensional array, consisting of a matrix having a plurality of cavities or slots arranged in an array and each capable of receiving a radiation detector module, and a processor in data communication with each said slot and module, said processor being adapted to receive and process radiation data from said radiation detector modules and provide said processed data to a user. Through the use of a modular configuration, according to the present invention, the replacement of a defective radiation detector does not require replacement of the entire assembly or array.

A feature of the invention is that said slots or cavities comprise electrical connectors for establishing data communication between the radiation detector modules and an external processor. Another feature of the invention is that said radiation detector modules comprise preferably detectors that may be ion chamber detectors or solid-state detectors, which can comprise one or more diodes, or other type of solid-state radiation detectors.

An important feature of the invention is that each said solid state detector module further comprises one or more integrators to receive a signal from each said diode, and one or more multiplexers adapted to receive an address and use said address to determine which diode signal to route through to said on-board processor. In this respect, the apparatus of the invention may further comprise a matrix multiplexer to address each said radiation detector module, and, in a more sophisticated development, the matrix multiplexer is configured to address each said diode within each said radiation detector module. In another aspect of the invention said radiation data is analog and said on-board processor further comprises analog to digital converters to convert said analog signals.

According to the invention, the objects as stated above are carried out by a novel method of analyzing a radiation beam, comprising the steps of providing a matrix having a plurality of slots or cavities arranged in an array, providing a plurality of radiation detector modules each having a plurality of radiation detectors, inserting the plurality of radiation detector modules into the slots so that they can be readily removed for replacement whereby the slots removably receive said radiation detector modules, providing an on-board processor, electrically connecting the plurality of slots to the processor to be able to pass the outputs of the radiation detectors of the plurality of radiation detector modules to the processor, interposing said matrix into the path of a radiation beam to generate outputs from said radiation detectors, multiplexing the received outputs from each said radiation detector to the processor, and processing said data for display to a user.

Another aspect of the method comprises providing a processor for addressing each individual radiation detector module and receiving therefrom its output of radiation data. In another aspect of the method said processor is programmed to indicate when a said radiation detector module has failed, and to indicate that fact to the user. In another aspect of the method said processor is programmed to detect and indicate when said radiation detector modules need to be rotated. In another aspect of the method said radiation beam is a high energy photon or electron beam. Another aspect of the method further comprises the steps of periodically rotating (switched in location) radiation detector modules with higher accumulated dose levels with those having lower accumulated dose levels.

A further inventive aspect is a machine-readable storage medium having a set of instructions, readable by machine, for analyzing radiation beams by executing the instructions according to a method comprising the steps of receiving radiation data from a plurality of radiation detector modules removably mounted in a matrix, said matrix placed in the path of said radiation beam, and processing said data for display to a user, and indicating to the user when said radiation detector module exposed to higher levels of radiation energy need to be rotated with those exposed to lower levels of radiation energy. As a further step, the method includes individually addressing each said radiation detector module to receive radiation data from one said radiation detector module at a time.

### BRIEF DESCRIPTION OF THE DRAWINGS

FIG. 1 shows a typical matrix system of the invention.

FIG. 2 is a schematic of a detector module of the invention.

FIG. 3 is a schematic of a system architecture of the invention.

### DETAILED DESCRIPTION OF PREFERRED EMBODIMENTS OF THE INVENTION

The invention disclosed herein enables a real-time characterization of a radiation beam—whether in therapy or any other application—by employing an array of detectors. The device may employ solid state (e.g., diodes), ion chambers, or any other type of radiation detector or combination of detectors.

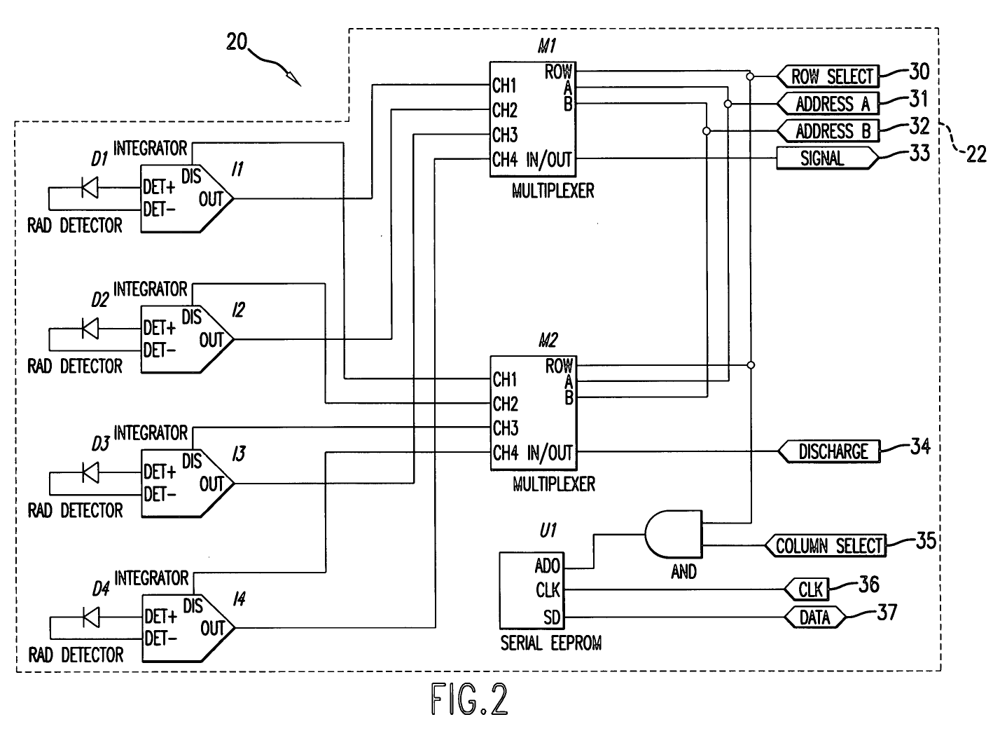

Referring to FIG. 2, a radiation detector module according to the invention is shown.

The module 20 is composed of individual radiation detectors (here, shown as diodes D1 through D4) are assembled into a basic array of elements, such as on a circuit board indicated by the dotted line 22. Alternatively, the detectors can be made as an integrated circuit on a semiconductor chip with all connections shown in FIG. 2 and other components included as components on the chip. As can be seen, the diode-type detectors D1-4 have outputs which are fed to integrators 11 through 14 for onboard or local processing the integrated signals are channeled through multiplexers M1 and M2, also on-board components. This enables individual addressing of the detectors by simply applying column and row select signals (pins 30,35) in conjunction with an address (pins 31,32). Of course, there are many ways to execute such functionality, so FIG. 2 is to be considered merely illustrative of one preferred embodiment showing schematically how to achieve this functionality. A serial EEPROM model U1 serves as an input for clock signals and data via pins 36 and 37. An AND gate is mounted on-board with the detectors D14 and is connected to the EEPROM and receives COLUMN SELECT signals via pin 35. The output from the AND gate connects with the multiplexers M1-2.

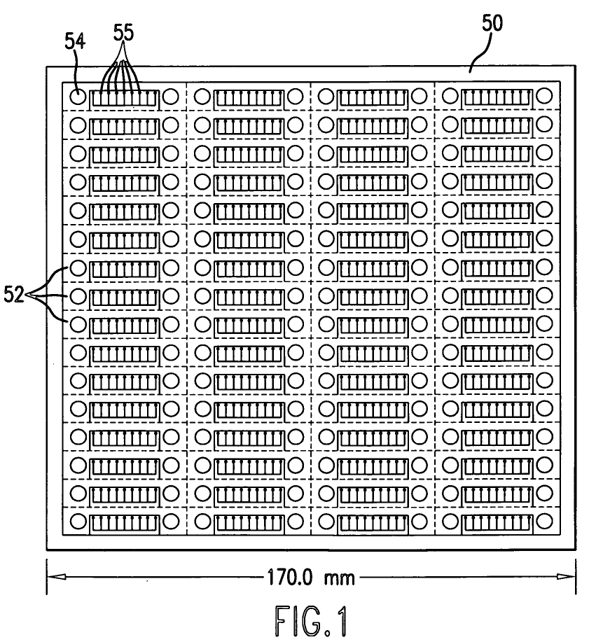

The plurality of pins numbered 30-37 enable the board 22 to be plugged into a matrix board 50 as shown in FIG. 1, which provides a plurality of cavities 52 into which each module 20 can be plugged in, using mounting pins for reception into mounting holes 54 and sockets 55 to receive the pins 30-37 of the module 20. Referring to FIGS. 1 and 2, the modules 20 are plugged into a matrix 50 that comprises hole patterns, or slots 52, for the modules to be plugged into. Not all the slots need be fitted with modules. Each slot will comprise a plurality of electrical connectors 55 for electrical communication with the module plugged therein. Additionally, each slot 52 will generally have an optional physical connector 54, such as holes, pins, snap-locks or other suitable means for securely detachably holding each module 20 in a slot 52.

The number and configuration of radiation detector modules 20 may be modified to meet the requirements of the user. For example, a line of these modules may be plugged into the matrix to construct a linear array of detectors. Alternatively, an n×n array of these modules may be plugged into the matrix to build a two-dimensional detector array. Many other specialize patterns may be constructed as desired. The important point is that the invention permits the user to build the exact configuration required to meet the need.

FIG. 1 is a particular example of a general schematic of the device that is a unique aspect of this invention, namely the modular design. In FIG. 1, the configuration illustrated is that of an array consisting of sixty-four detector modules 20 arranged in four columns of sixteen modules each. In addition, each one of these detector modules 20 contains four radiation detectors. Therefore, FIG. 1 represents an array consisting of 256 detectors arranged in a 16×16 array.

A key feature of the invention is this modular strategy. This modular array is a unique aspect of the invention, rendering it superior to the prior art in a number of ways. Before explaining the disclosed embodiment of the present invention in more detail, it is to be clearly stated and understood that the invention is not limited in its application to the details of the particular arrangement that is depicted in FIGS. 1-3 since the invention is capable of many other embodiments. Also, the terminology used herein is for the purpose of description and not of limitation.

FIGS. 1-3 is a particular example of a general schematic of the method, concept, and device that is the foundation and of central importance to this invention, specifically, the modular design. In FIG. 1, the configuration shown is that of an array consisting of 64 modules (as earlier defined) arranged in 16 rows and 4 columns with 4 modules per row (total 256). In addition, each one of these modules may contain between 1 and 4 radiation detectors with vertical stacking of detectors. Therefore, FIG. 1 represents an array consisting of 256 to 1024 detectors arranged in a 4×16 rectangular pattern. It warrants re-stating that the invention is not limited in its application to the details of the particular arrangement that is depicted in FIGS. 1-3 since the invention is capable of many other embodiments. For instance, instead of this (rectangular) arrangement, a square (5×5) or some other regular geometrical or some irregular (non-symmetrical) arrangement may be produced employing the same modular approach which is the essence of the invention. Thus, the modular design enables on-site customization of the array pattern—this is a unique aspect of the invention.

Further, another unique aspect of the invention is modular processing. Processing of the signal acquired by the individual detectors is done at the modular level, as indicated in FIG. 2. Specifically, signal integration and other processing may be carried out at each individual module. This allows radiation detector modules of different types to be used interchangeably.

If, however, the user intends only to use one type of detector module, such as the diode-type shown in FIG. 2, then much or all of the circuitry may be moved to the matrix. For example, the module of FIG. 2 may be modified to include only the diodes and the rest of the circuitry moved to the matrix. This would be desirable to save costs, because the modules are to be considered “disposable,” as it is anticipated they will degrade and fail over time due to exposure to large doses of high energy radiation.

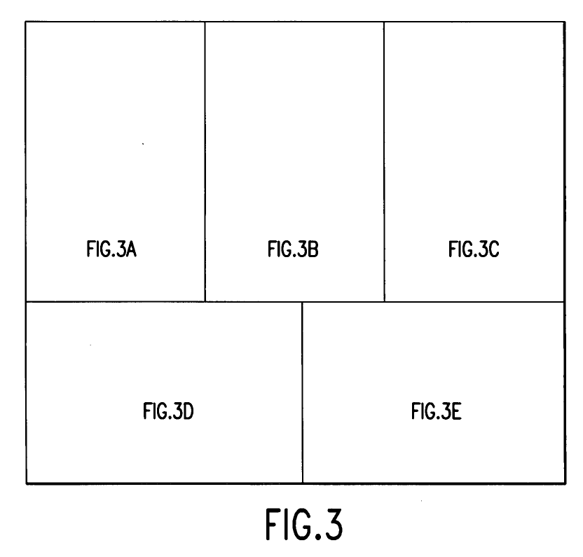

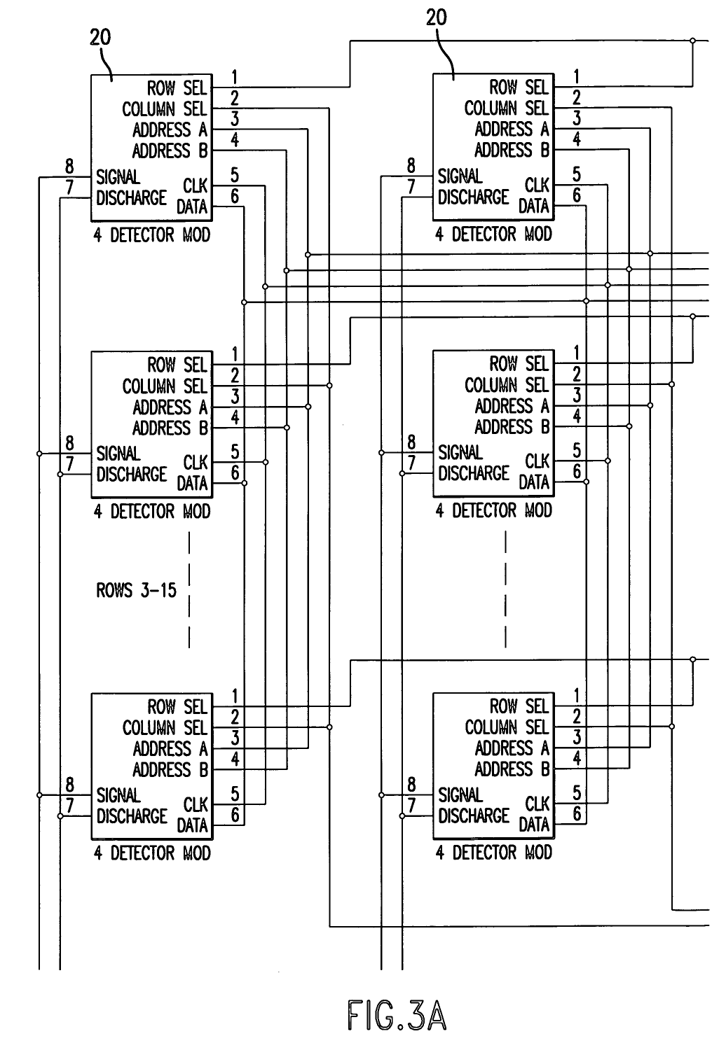

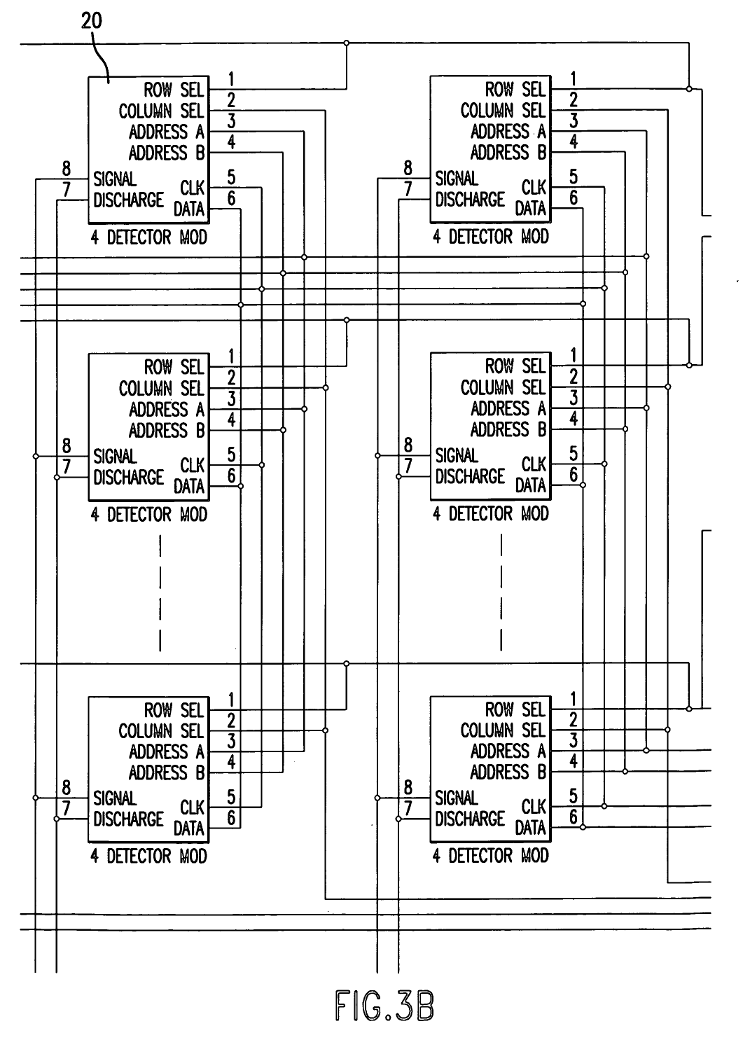

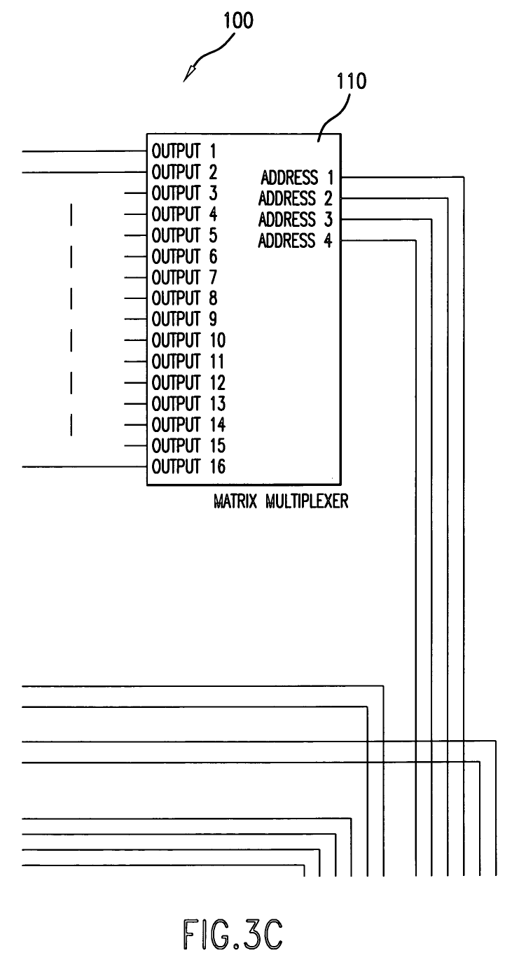

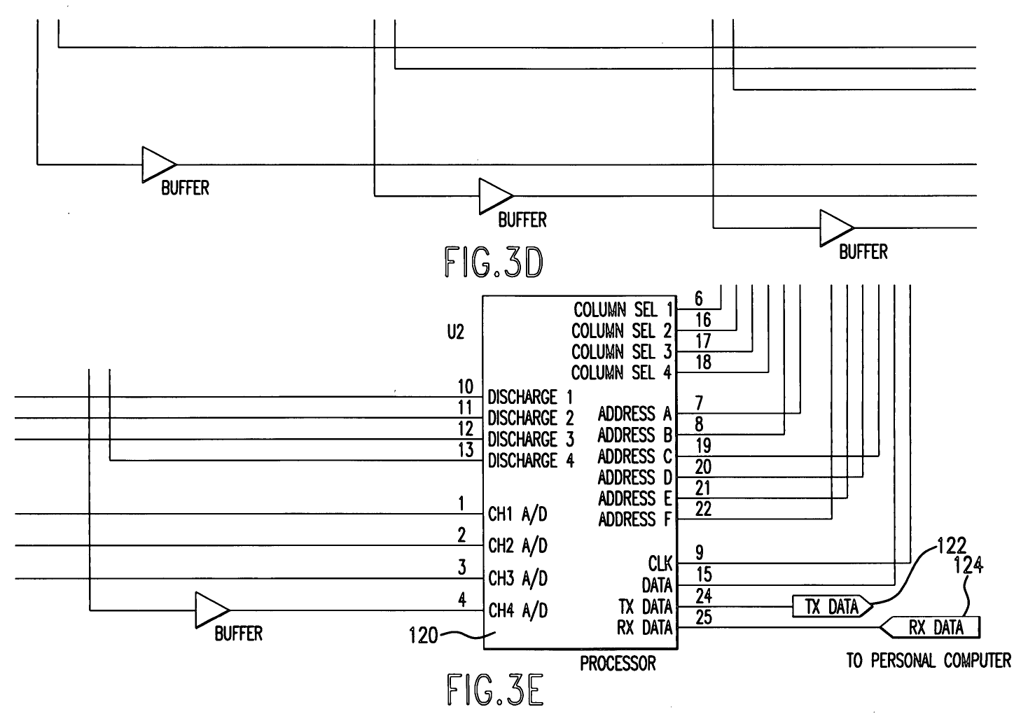

Referring to FIG. 3, there is shown a preferred embodiment of the system architecture 100 of the radiation beam analyzer of the invention. The processed signals from each module 20 are addressed by an on-board matrix multiplexer 110 under the control of an on-board matrix processor 120. The output signals from the radiation detector modules 20 are then input into A/D converters, which in the drawing are integrated into the processor 120. These digital data are now ready to be mathematically processed and displayed to the user, and are output via pins 122 and 124, which may connect via an RS232 cable to a PC or other computer. This design is superior to, and has many advantages over, any present system by offering greater simplicity, capability, reliability, and maintainability all at lower cost.

Note that it is preferable to execute the analog to digital conversion outside of each individual radiation detector module 20 because of the disposable nature of the modules. Hence, disposing of valuable circuitry and save costs is avoided.

The operations of the processor 120 will generally be carried out by a program of instructions executable by machine. The instructions will generally be stored on a medium, readable by machine, such as RAM, diskette, or hard drive, as is known in the art. The program of instructions will preferably include instructions indicating to the user when a module has failed or is degrading, such that the user will know when to replace or rotate modules.

The modular design also provides for numerous advantages over existing systems in matters regarding radiation damage, manufacturing, maintenance and repair. In prior art arrays, the incapacitation of an array element during manufacturing or due to radiation damage generally means a costly, time-consuming repair process, because the entire array is built as a single, integrated platform. The modular approach of the invention, on the other hand, allows that when a single detector module contains a defective detector and is therefore defective, then, that element and only that element need be replaced. This feature makes for a more robust design and enhances the manufacturing process significantly. Also, the modular design of the device enables this type of “repair” to be done by the user simply by extracting the damaged module and replacing it with a new module. With current systems, the user has no choice but to send the complete unit to the manufacturer for repair. The time and cost implications of our modular concept and design to the end user are readily apparent.

The modular concept actually extends the life of the modules. Modules closest to the center will generally be subjected to larger doses of radiation than those near the periphery of the array. These interior modules will therefore degrade faster in the presence of high energy radiation. Because of the modular design of the invention, it is a relatively simple matter to periodically rotate interior modules with the exterior modules. This ability to rotate modules will prolong the modules' life resulting in fewer overall repairs to the device. In present systems, radiation damage to any part of the array renders the entire array defective in some way.

While various values, scalar and otherwise, may be disclosed herein, it is to be understood that these are not exact values, but rather to be interpreted as “about” such values, Further, the use of a modifier such as “about” or “approximately” in this specification with respect to any value is not to imply that the absence of such a modifier with respect to another value indicated the latter to be exact. Changes and modifications can be made by those skilled in the art to the embodiments as disclosed herein and such examples, illustrations, and theories are for explanatory purposes and are not intended to limit the scope of the claims.

While the invention has been described, disclosed, exemplified, illustrated and shown in various terms of certain embodiments or modifications which it has presumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

What is claimed is:

1. A radiation beam analyzer, comprising:
a matrix having a plurality of slots for removably receiving one or more radiation detector modules; and
a processor in data communication with each said module, said processor adapted to receive and process radiation data from said radiation detector modules and provide said processed data to a user.

2. The apparatus of claim 1 wherein said slots comprise electrical connectors for establishing data communication between said radiation detector modules and said processor.

3. The apparatus of claim 1 wherein said radiation detector modules comprise ion chamber detectors.

4. The apparatus of claim 1 wherein said radiation detector modules comprise solid-state detectors.

5. The apparatus of claim 4 wherein each said solid state detector comprises one or more diodes.

6. The apparatus of claim 5 wherein each said solid state detector further comprises:
one or more integrators to receive a signal from each said diode; and
one or more multiplexers adapted to receive an address and use said address to determine which diode signal to route through to said processor.

7. The apparatus of claim 1 further comprising a matrix multiplexer to address each said radiation detector module.

8. The apparatus of claim 5 further comprising a matrix multiplexer to address each said diode within each said radiation detector module.

9. The apparatus of claim 1 wherein said radiation data is analog and said processor further comprises analog to digital converters to convert said analog signals.

10. A method of analyzing a radiation beam, comprising the steps of:
providing a plurality of radiation detector modules;
providing a matrix having a plurality of slots for removably receiving said radiation detector modules;
placing said matrix in the path of the radiation beam;
receiving from each said module radiation data; and
processing said data for display to a user.

11. The method of claim 10 further comprising:
providing a processor for addressing each individual radiation detector module and receiving said radiation data therefrom.

12. The method of claim 11 wherein said processor is programmed to indicate when a said radiation detector module has failed.

13. The method of claim 11 wherein said processor is programmed to indicate when said radiation detector modules need to be rotated.

14. The method of claim 10 wherein said radiation beam is a high energy beam.

15. The method of claim 10 further comprising the steps of:
periodically rotating radiation detector modules exposed to higher energy levels with those exposed to lesser energy levels.

16. A machine-readable storage medium having a set of instructions, readable by machine, for analyzing radiation beams by executing a method comp rising the steps of: receiving radiation data from a plurality of radiation detector modules removably mounted in a matrix, said matrix placed in the path of said radiation beam; and processing said data for display to a user.

17. The apparatus of claim 16 further comprising the steps of:
individually addressing each said radiation detector module to receive radiation data from one said radiation detector module at a time.

18. The apparatus of claim 16 further comprising the steps of:
indicating to the user when said radiation detector module exposed to higher levels of radiation energy need to be rotated with those exposed to lower levels of radiation energy.

19. The apparatus of claim 16 further comprising the steps of:
indicating to the user when a said radiation detector module has failed.
